(19) United States
(12) Patent Application Publication
(10) Pub. No.: US 2023/0016827 A1
(43) Pub. Date: Jan. 19, 2023

(54) ADAPTIVE OFFLOADING OF FEDERATED LEARNING

(71) Applicant: RAKUTEN MOBILE, INC., Tokyo (JP)

(72) Inventors: Di WU, Belfast (GB); Rhemat ULLAH, Belfast (GB); Paul HARVEY, Tokyo (JP); Peter KILPATRICK, Belfast (GB); Ivor SPENCE, Belfast (GB); Blesson VARGHESE, Belfast (GB)

(21) Appl. No.: 17/523,920

(22) Filed: Nov. 11, 2021

Related U.S. Application Data
(60) Provisional application No. 63/219,797, filed on Jul. 8, 2021.

(51) Int. Cl. G06N 3/08; G06N 3/04

(52) U.S. Cl. CPC G06N 3/08; G06N 3/04

(57) ABSTRACT

Adaptive offloading of federated learning is performed by partitioning, for each of a plurality of computational devices, a plurality of layers of a neural network model into a device partition and a server partition based on a computational capability attribute of the computational device and a network bandwidth attribute of the computational device, training, cooperatively with respect to each computational device through the network, the neural network model, and aggregating the updated weight values of neural network model instances received from the plurality of computational devices to generate an updated neural network model.

### PRIORITY CLAIM AND CROSS-REFERENCE

This application claims priority to Provisional Application No. 63/219,797, filed Jul. 8, 2021, which is hereby incorporated by reference in its entirety.

### BACKGROUND

Federated Learning (FL) is a machine learning (ML) technique used to preserve privacy. Using some FL techniques, training of an ML model, such as a Deep Neural Network (DNN), is executed on several Internet-of-Things (IoT) devices, without sending raw input data, which may be sensitive, from the devices through a network. Instead, a server is sent intermediate models generated by the devices that are aggregated on the server to create a global model. Using such techniques, an ML model is able to be trained without exposing sensitive data from a device to the network. Using some FL techniques, the training of the DNN is executed on the device while an external server on the network aggregates the weights sent from the devices, which is relatively less computationally expensive than training of the DNN. Aggregation is the process for updating the global model on the server that is then sent to the devices for continued training. The devices train independently and are able to connect the devices to the server through diverse network configurations.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of data flow for adaptive offloading of federated learning, according to at least one embodiment of the present invention.

FIG. 2 is an operational flow for adaptive offloading of federated learning, according to at least one embodiment of the present invention.

FIG. 3 is an operational flow for cooperative training, according to at least one embodiment of the present invention.

FIG. 4 is an operational flow for neural network model partitioning, according to at least one embodiment of the present invention.

FIG. 5 is a schematic diagram of data flow for neural network model partitioning, according to at least one embodiment of the present invention.

FIG. 6 is a block diagram of an exemplary hardware configuration for adaptive offloading of federated learning, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In some cases, an ML model utilizes a computationally intensive workload for training, and yet FL is sometimes executed on devices that are relatively resource constrained when compared to large servers or clusters that have specialized processors for training ML models. In such cases, the time taken to train ML models on devices is often very significant, which makes FL impractical for such ML models. Furthermore, because IoT devices connected to a server for FL often have varying computational capabilities or heterogeneous architectures, stragglers, i.e.—devices that require a longer time for training than the other devices, arising from computational heterogeneity of such IoT devices may become bottlenecks during training. This is because the aggregating server waits until all devices have completed training before beginning the aggregation. If the aggregating server does not wait until all devices have completed training, then the accuracy of the global model is affected since all devices will not contribute equally to training. Other conditions, such as the network bandwidth between a device and the server, which vary during the course of training, tend to increase training time.

In some techniques, each round of FL comprises three steps. In the first step, a global model is initialized on the server and distributed to all devices. Each device independently trains an ML model using data generated by the device. In some techniques, one epoch of local training utilizes the entire dataset from each device. After independently training, in the second step, the ML models from the local devices, which have updated weights and/or other model parameters, are sent to the server. In the third step, a new global model is aggregated using methods such as Federated Averaging on the server. In subsequent rounds of FL training according to some techniques, the aggregated model is again distributed to all devices and the three steps are repeated until the training loss convergences, a time limit is exceeded, or some other termination condition is met. Training is performed independently on each device, which provides FL some scalability. However, some FL techniques are less efficient when performed with heterogeneous devices, i.e.—devices that have different computational capabilities.

In some Split Learning (SL) techniques, a monolithic DNN is partitioned into two networks, which may be referred to as a device partition and a server partition. On the device side according to some techniques, the DNN is trained up to the layer at which the DNN is partitioned, referred to as the partition layer. Then, the activation feature map of the partition layer is sent to the server. Using the feature map as input to the server partition, the server continues training until the last layer of the DNN. After the server calculates the training and updates the gradient, the respective gradients of the feature map are sent to the device so that the device can update the gradients of the device partition. Since input data from the device is not sent to the server, preservation of privacy is increased.

According to some SL techniques, multiple devices are trained in a sequential round robin fashion, whereby only one device will be connected to the server at a time. Once a given device completes training, the updated weights are copied onto the next device to continue training. Partitioning the DNN allows devices with limited computational resources to be responsible for fewer computations. By instructing less capable devices to train fewer layers, computation work load can be reduced. SL techniques that sequentially train across devices lose efficiency as the number of devices increases.

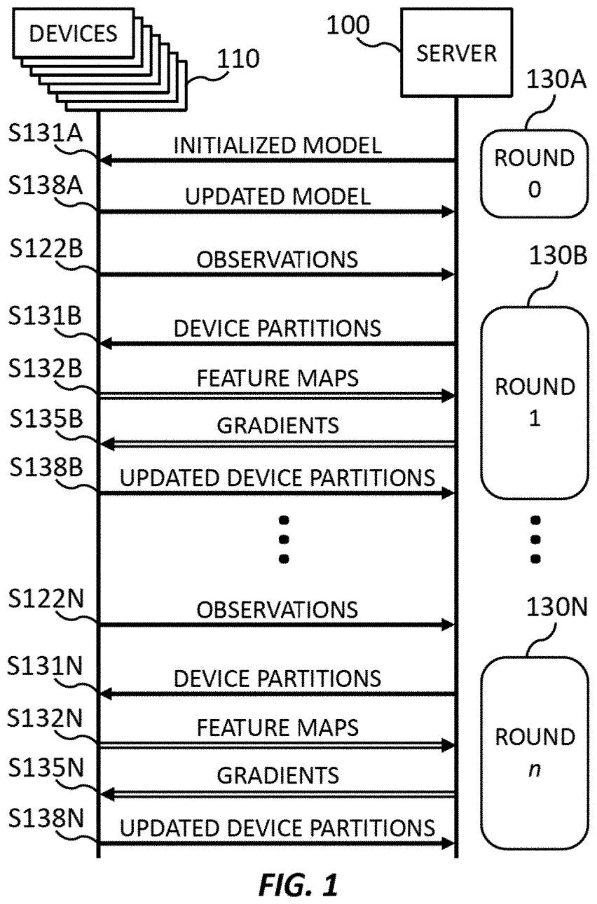

FIG. 1 is a schematic diagram of data flow for adaptive offloading of federated learning, according to at least one embodiment of the present invention. The diagram includes a plurality of devices 110 and a server 100.

Devices 110 are computational devices capable of performing calculations to train a neural network or other machine learning function. In at least some embodiments, devices 110 are heterogeneous, meaning the devices have varying computational resources, such as processing power, memory, etc. In at least some embodiments, devices 110 receive private information, either by detecting it directly, such as through onboard microphones, cameras, etc., or by receiving data through electronic communication with another device, and use the private information as training data. In at least some embodiments, the training data is not private information or is a mixture of private and non-private information. In at least some embodiments, devices 110 are in communication with server 100 through a wide area network, such as the Internet, or a local area network.

Server 100 is computational device capable of performing calculations to train a neural network or other machine learning function, organizing devices 110 to cooperatively train the neural network, and aggregate neural networks to produce a global neural network. In at least some embodiments, the cooperative training is performed in “rounds”. In at least some embodiments, each round of cooperative training uses a batch of training data, which includes a plurality of samples. In at least some embodiments, the computational resources of server 100 are greater than all of the devices 110. In at least some embodiments, server 100 communicates with devices 110 through a wide area network, such as the Internet, or a local area network.

In Round 0 (130A), server 100 initializes a model for training. In at least some embodiments, server 100 initializes the neural network model with random weight values. In at least some embodiments, server 100 initializes a neural network model by establishing layers and dimensions, and assigning each weight to a random value between 0 and 1. At S131A, server 100 transmits the initialized model to each of devices 100. In at least some embodiments, server 100 transmits, to each of the plurality of computational devices through the network, a corresponding instance of the initialized neural network model. During Round 0 (130A), devices 110 receive the initialized model and train the model on the side of the device, without cooperation from server 100. In at least some embodiments, initially training the model without cooperation from server 100 allows server 100 to measure a baseline for evaluating computational capabilities of devices 110. At S138A, each device transmits the model with updated weights from the training to server 100. During Round 0 (130A), server 100 receives updated models from devices 110, and aggregates the updated models to generate a new global model with which to proceed to the next round. In at least some embodiments, server 100 receives, from each of the plurality of computational devices through the network, a corresponding instance of the neural network model having updated weight values. In at least some embodiments, server 100 aggregates the updated weight values of the instances of the neural network model received from the plurality of computational devices to generate an updated neural network model. In at least some embodiments, the updated neural network model is used as the neural network model in the partitioning of subsequent rounds. At S122B, server 100 receives observations from devices 110. In at least some embodiments, the observations are received between rounds. In at least some embodiments, the observations include the computational capabilities of each device, the amount of time each device spent training in the previous round, a measure of the network bandwidth from each device to server 100, or any other metric affecting the amount of time until server 100 receives the respective updated model. In at least some embodiments, server 100 determines between which layers to partition the global model for each device among devices 100 according to the observations between rounds.

In Round 1 (130B), for each device among devices 100, server 100 partitions the global model according to the observations into a device partition and a server partition. At S131B, server 100 transmits the device partitions to devices 110. During Round 1 (130B), in at least some embodiments, devices 110 receive the device partitions and train the device partitions on the side of the device, while server 100 trains the server partition. In at least some embodiments, the cooperative training between each device among devices 110 and server 100 occurs in iterations, each iteration involving one sample of training data. In at least some embodiments, each iteration begins with devices 110 receiving the sample and applying the device partition to the sample. At S132B, devices 110 send a feature map output form the device partition to server 100. In at least some embodiments, server 100 applies the server partition corresponding to the device to the feature map, updates the loss function based on the output of the corresponding server partition, and calculates the gradients of the corresponding server partition. At S135B, server 100 transmits the gradients of the bordering layer of the corresponding server partition to the device. In at least some embodiments, each device among devices 110 receives the gradients and calculates the gradients of the corresponding device partition. In at least some embodiments, the operations at S132B and S135B are performed for multiple iterations within a round at various times and frequencies, depending on the device. In at least some embodiments, the operation at S135B is not performed in every iteration, because the gradients and weights are not updated after every training sample is processed. At S138B, after all iterations of training are complete, and the weights of each device partition are fully updated, devices 110 transmit the updated models to server 100. In at least some embodiments, server 100 receives updated device partitions from devices 110, combines each device partition with the corresponding server partition to form a corresponding updated model, and aggregates the updated models to generate a new global model with which to proceed to the next round.

Subsequent rounds, Round 2 through Round N (S130N), include substantially the same operations as Round 1 (S130B). Before each subsequent round, observation is performed, such as at S122N before Round N (130N). The operations at S122B, S131B, S132B, S135B, and S138B are substantially similar to the operations performed before and during each subsequent round, including the operations at S122N, S131N, S132N, S135N, and S138N before and during Round N (130N). In at least some embodiments, the observations, such as at S122B and S122N, will change each round, which affects the location in which the global model is partitioned with respect to each device among devices 110.

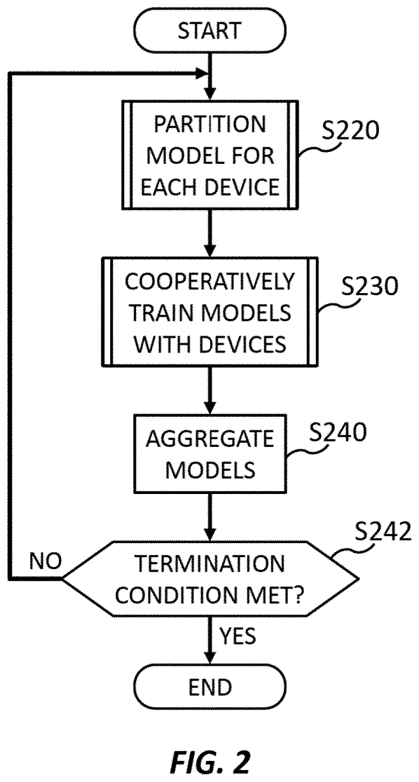

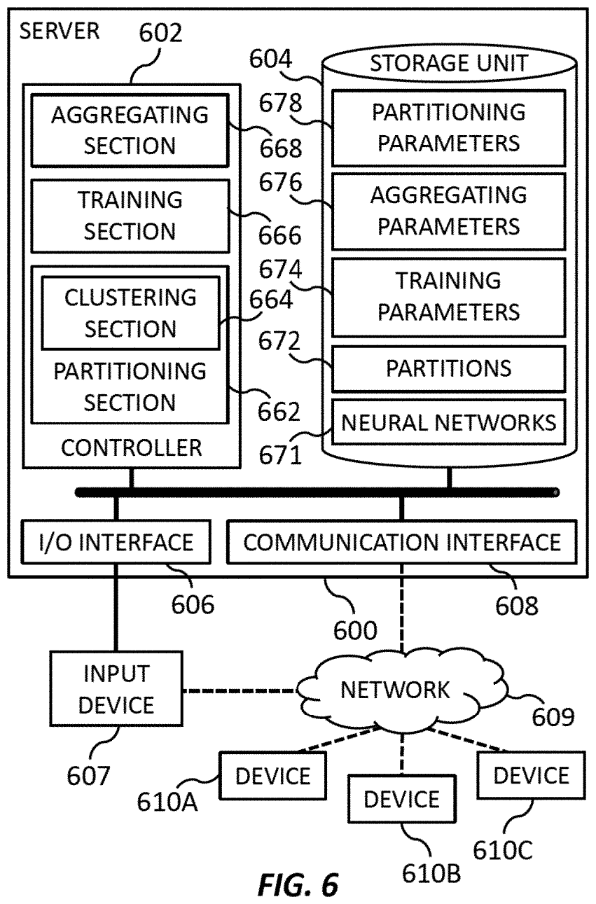

FIG. 2 is an operational flow for adaptive offloading of federated learning, according to at least one embodiment of the present invention. The operational flow provides a method of adaptive offloading of federated learning. In at least some embodiments, the method is performed by a controller of a server including sections for performing certain operations, such as the controller and server shown in FIG. 6, which will be explained hereinafter.

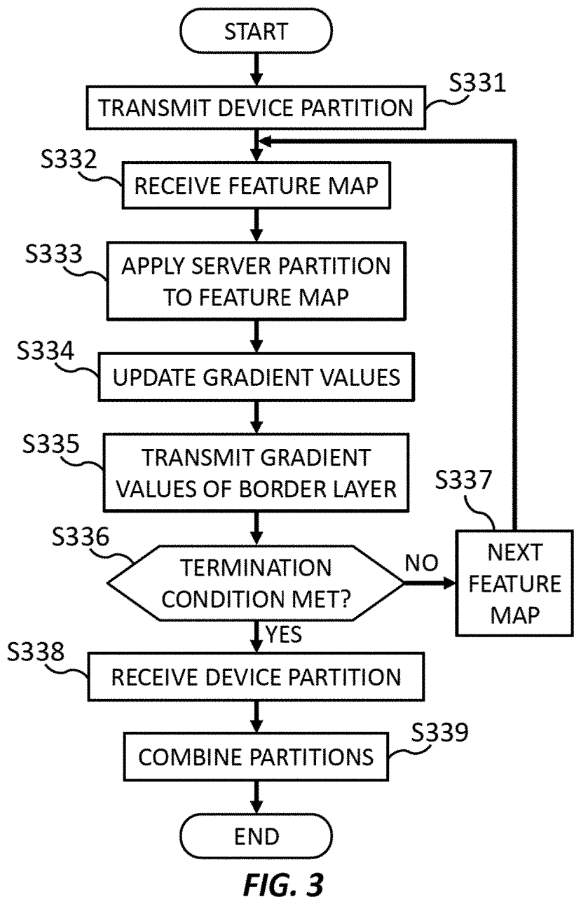

At S220, a partitioning section or a sub-section thereof partitions a global neural network model for each computational device among a plurality of computational devices. In at least some embodiments, the partitioning section partitions, for each of a plurality of computational devices, a plurality of layers of a neural network model into a device partition and a server partition based on a computational capability attribute of the computational device and a network bandwidth attribute of the computational device. In at least some embodiments, the partitioning section partitions the layers of the neural network for each computational device based on the individual computational capability attribute and network bandwidth attribute. In at least some embodiments, the partitioning section clusters the computational devices into groups, and partitions the layers of the neural network according to representative attributes of each group. In at least some embodiments, the partitioning section clusters each device having a network bandwidth attribute lower than a threshold value into one group, then clusters remaining computational devices into groups having common computational capability attributes. In at least some embodiments, the partitioning section uses an algorithm to determine the location in which the neural network model is partitioned. In at least some embodiments, the partitioning section uses a reinforcement learning model to determine the location in which the neural network model is partitioned. In at least some embodiments, the partitioning proceeds as shown in FIG. 3, which will be explained hereinafter.

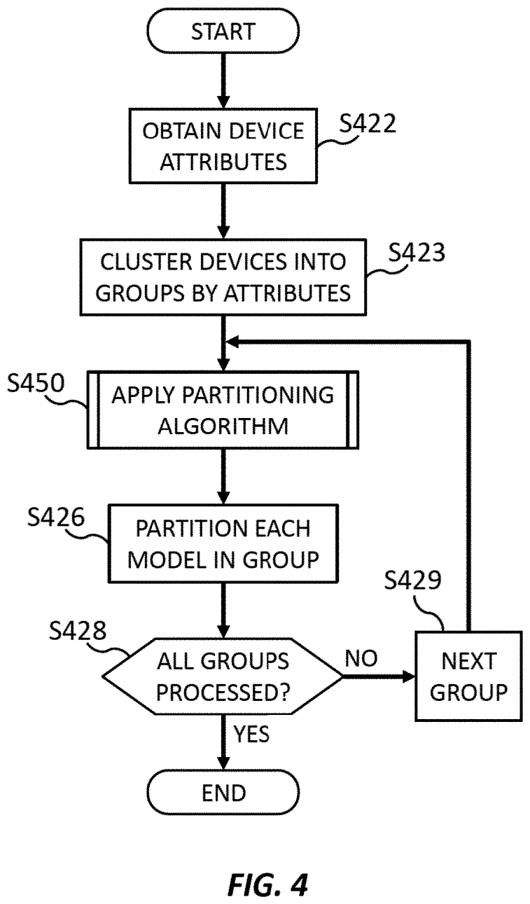

At S230, a training section or a sub-section thereof cooperatively trains neural network models with the computational devices. In at least some embodiments, the training section iteratively receives feature maps from each computational device, and applies a corresponding server partition to the feature map. In at least some embodiments, after one or more iterations the training section updates the loss function, calculates gradients values in the corresponding server partition, and transmits the gradient values in the bordering layer of the corresponding server partition to each device. In at least some embodiments, after the last iteration, the training section receives a corresponding device partition from each computational device. In at least some embodiments, the training section combines each device partition with the corresponding server partition to form complete network model instances. In at least some embodiments, the training section trains, cooperatively with respect to each computational device through the network, the neural network model by proceeding as shown in FIG. 4, which will be explained hereinafter.

At S240, an aggregating section or a sub-section thereof aggregates the neural network model instances to generate an updated global neural network model. In at least some embodiments, the aggregating section aggregates the updated weight values of neural network model instances received from the plurality of computational devices to generate an updated neural network model. In at least some embodiments, the aggregating section averages the gradient values across the neural network model instances, and calculates the weight values of the global neural network model accordingly. In at least some embodiments, the aggregating section averages the weight values across the neural network model instances. In at least some embodiments, the plurality of computational devices apply different amounts of training data at S230, and the aggregating section averages the weight values across the neural network model instances proportionally to the number of samples of training data applied at S230. In at least some embodiments, a round of federated learning is complete when the aggregating section generates the updated global neural network model.

At S242, the controller or a sub-section thereof determines whether a termination condition has been met. In at least some embodiments, the termination condition is met when the training loss convergences. In at least some embodiments, the termination condition is met when a time limit is exceeded. If the controller determines that the termination condition has not been met, then the operational flow returns to neural network model partitioning at S220. If the controller determines that the termination condition has been met, then the operational flow ends.

In at least some embodiments, the controller performs a plurality of rounds, each round including the partitioning at S220, the training at S230, and the aggregating at S240, wherein, for each round, the neural network model subjected to the partitioning and the training is the updated neural network model resulting from the aggregating of a preceding round.

FIG. 3 is an operational flow for cooperative training, according to at least one embodiment of the present invention. The operational flow provides a method of cooperative training with respect to a single computational device. In at least some embodiments, the method is performed by a training section of a controller, such as the controller shown in FIG. 6, which will be explained hereinafter. In at least some embodiments, the training section performs the operations of the cooperative training process at various times with respect to multiple computational devices. In at least some embodiments, the training section is able to perform more than one operation with respect to more than one computational device at the same time.

At S331, the training section or a sub-section thereof transmits, to each computational device, a corresponding device partition. In at least some embodiments, the training section transmits the device partitions once at the beginning of each round of the training process. In at least some embodiments, the training section sends device partitions to all computational devices at substantially the same time.

At S332, the training section or a sub-section thereof receives a feature map from a computational device. In at least some embodiments, as iterations of S332 proceed with respect to a single computational device, the training section receives, from the computational device, feature maps output from the corresponding device partition.

At S333, the training section or a sub-section thereof applies the server partition to the feature map received at S333. In at least some embodiments, as iterations of S333 proceed with respect to a single computational device, the training section applies the corresponding server partition to the feature maps.

At S334, the training section or a sub-section thereof updates the gradient values of the server partition. In at least some embodiments, the training section updates weight values of the server partition. In at least some embodiments, the training section updates the gradient values based on a loss function. In at least some embodiments, the loss function relates expected output of the feature maps to actual output of the server partition. In at least some embodiments, as iterations of S334 proceed with respect to a single computational device, the training section updates gradient values and weight values of the layers of the corresponding server partition based on a loss function relating feature maps to output of the corresponding server partition. In at least some embodiments, the training section does not update gradient values in each iteration of the operations at S332 to S335. In at least some embodiments, the training section does not update the gradient values once for every feature map received from the device partition. In at least some embodiments, the training section only updates the gradient values once per a predetermined number of feature maps received, or some other criteria.

At S335, the training section or a sub-section thereof transmits the gradient values of the layer of the server partition that borders the device partition. In at least some embodiments, as iterations of S335 proceed with respect to a single computational device, the training section transmits, to the computational device, gradient values of a layer bordering the corresponding device partition. In at least some embodiments, the training section does not transmit gradient values in each iteration of the operations at S332 to S335. In at least some embodiments, the training section transmits gradient values only in response to updating gradient values at S334.

At S336, the training section or a sub-section thereof determines whether a termination condition has been met. In at least some embodiments, the termination condition is met when a complete set of training data has been processed by the computational device. In at least some embodiments, the termination condition is met when a time limit is exceeded. If the training section determines that the termination condition has not been met, then the operational flow returns to feature map reception at S332. If the training section determines that the termination condition has been met, then the operational flow proceeds to device partition reception at S338.

At S337, the training section or a sub-section thereof prepares to receive the next feature map. In at least some embodiments, the training section merely awaits the computational device to process the next sample of training data. In at least some embodiments, the training section performs one or more of the operations at S332 to S335 with respect to one or more other computational devices. In at least some embodiments, the training section performs the operations at S332 to S335 with respect the computational devices at various and overlapping times. In at least some embodiments, because the computational devices are heterogeneous, the training section is configured to respond to any computational device at any time with any request or data.

At S338, the training section or a sub-section thereof receives, from the computational device, the corresponding device partition. In at least some embodiments, the training section receives, from the computational device, the corresponding device partition having updated weight values.

At S339, the training section or a sub-section thereof combines the device partition received at S338 with the corresponding server partition. In at least some embodiments, the training section combines the corresponding server partition having updated weight values with the corresponding device partition having updated weight values to form a corresponding neural network model instance having updated weight values.

In at least some embodiments, after a FL round has been completed, such as the operations at S230 and S240 shown in FIG. 2, the server observes attributes on the current state of the computational devices, such as computational capability attributes and network bandwidth attributes between each computational device and the server. In at least some embodiments, the training time per iteration is normalized by the partitioning section. In at least some embodiments, a clustering section clusters computational devices with similar normalized training time into a single group, such that all devices within a group are considered as homogeneous. In at least some embodiments, the clustering section further optimizes the clustering by accounting for network bandwidth between each computational device and the server. In at least some embodiments, a partitioning algorithm is applied to the group information and observations to generate an offloading decision, which represents a ratio used to determine a partitioning location for each group. In at least some embodiments, the partitioning algorithm is an agent using a fully-connected neural network trained by Reinforcement Learning (RL), which is applied to a state representing the group information and observations to generate an action in the form the offloading decision. In at least some embodiments, the partitioning section uses the output of the partitioning algorithm and maps the offloading decision for each group obtained onto the devices in the group, the mapping referred to as an Offloading Strategy. In at least some embodiments, all computational devices in a group execute the same offloading strategy. The offloading strategy indicates which layers of the DNN model will be in a corresponding device partition trained by each device for an FL Round. In at least some embodiments, the observation, clustering, and partition determination, are all part of the partitioning process, such as the neural network model partitioning at S220 shown in FIG. 2.

FIG. 4 is an operational flow for neural network model partitioning, according to at least one embodiment of the present invention. The operational flow provides a method of neural network model partitioning. In at least some embodiments, the method is performed by a partitioning section of a controller, such as the controller shown in FIG. 6, which will be explained hereinafter.

At S422, the partitioning section or a sub-section thereof obtains attributes from each computational device. In at least some embodiments, the partitioning section obtains the computational capability attribute and the network bandwidth attribute for each of the plurality of computational devices. In at least some embodiments, the partitioning section obtains, from each computational device, a value representing the amount of time that the computational device spent training the device partition of the neural network model from the previous round of training.

At S423, the partitioning section or a sub-section thereof clusters the computational devices into groups based on the attributes obtained at S422. In at least some embodiments, the partitioning section clusters, into a group among a plurality of groups, one or more computational devices among the plurality of computational devices based on a similarity of the computational capability attribute of each computational device and further based on a similarity of the network bandwidth attribute of each computational device. In at least some embodiments, the partitioning section clusters the computational devices into a predetermined number of groups. In at least some embodiments, the partitioning section clusters the computational devices into groups using a clustering algorithm, such as a clustering model. In at least some embodiments, the partitioning section performs the partitioning is based on the group of each computational device. In at least some embodiments, the partitioning section determines, for each group, one or more representative attributes based on which to perform the partitioning.

At S450, the partitioning section or a sub-section thereof applies a partitioning algorithm to a group of computational devices. In at least some embodiments, the partitioning section applies a partitioning algorithm that relates a training time of each group to the computational capability attributes of the corresponding group among the plurality of groups obtained during the preceding round, the network bandwidth attributes of the corresponding group among the plurality of groups obtained during the preceding round, a computational capabilities attribute of the server, a number of computations performed by the corresponding device during the training, and a partition location within the neural network model, the training time of each group being a representative amount of time used during the training. In at least some embodiments, the partitioning section applies the partitioning algorithm to the one or more representative attributes of the group of computational devices. In at least some embodiments, the partitioning section determines an offloading decision, which, when applied to one or more neural network models to be trained, indicates which layers are partitioned into the device partition and which layers are partitioned into the server partition. In at least some embodiments, the offloading decisions for the groups of computational devices are collectively referred to as an offloading strategy. In at least some embodiments, the partitioning section determines, according to the partitioning algorithm for each group, a partition location that reduces the corresponding training time. In at least some embodiments, the partitioning section determines, for each group of computational devices, a partition location that minimizes the total sum amount of time that the groups of computational devices spend training. In at least some embodiments, the partitioning algorithm is a partitioning model trained to output the partition location using a loss function based on the training time. In at least some embodiments, the determination of partition locations has a significant impact on the performance of the training process, the partition location dictates the amount of computations that are offloaded from the computational device into the server. In at least some embodiments, the determination of partition locations is anticipated to accelerate FL training since the computational workload is transferred to more capable resources that may be available on the server.

In the approach to determining partition locations used in at least some embodiments, the partitioning section identifies, for each computational device, the layer after which the DNN model is partitioned, referred to as the Offloading Point (OP). In at least some embodiments, the initial layers of the DNN that remain on the device are referred to as the “device partition, whereas the layers after the OP offloaded to the server are referred to as the “server partition”. During training in at least some embodiments, the intermediate activation and corresponding labels and gradients of the distributed DNN are exchanged between the computational devices and server. Although there are communication overheads in transferring the activation and gradients during training, the overall FL training time in at least some embodiments is reduced due to the gain by computational offloading.

In at least some embodiments, the partitioning section assumes that the network bandwidth between the device and the server can change between different FL rounds. In at least some embodiments, the partitioning section observes the network bandwidth from the previous FL round for generating an offloading strategy. In at least some embodiments, the partitioning section does not account for any changes to network bandwidth during a round. In at least some embodiments, the partitioning section ultimately reduces the overall training time of all FL rounds by achieving suitable offloading strategies for all devices and adapting to observable network changes.

In at least some embodiments, the training process is modeled as follows for the purpose of partitioning. Training is scheduled for R rounds with K computational devices. Each computational device has a training workload W^{k} for each round. An FL training operation involving a server s has training speed Cₜ^{s} at round t and a set of participating computational devices {k}ₖ₌₁^{K} with training speed Cₜ^{k} and network bandwidth between the computational device and the server Netₜ^{k}. The offloading strategy for the computational device is μₜ^{k}. The training time for computational device k at round t is calculated with a function ƒ as follows:

Tₜ^{k}=ƒ(W^{k}, Cₜ^{s}, Cₜ^{k}, Netₜ^{k}, μₜ^{k}) EQ. 1,

where ƒ is a function that maps W^{k}, Cₜ^{s}, Cₜ^{k}, Netₜ^{k}, μₜ^{k} to training time Tₜ^{k}.

When FL training time Tₜ for a round, t ∈ [1, R] is considered, then in round t, W^{k}, Cₜ^{s}, Cₜ^{k} and Netₜ^{k} are either constant or variables not accounted for in at least some embodiments. The only variable is the offloading strategy for each computational device μₜ^{k}, which is an OP. The collection of OPs for K computational devices is μₜ, which is {μₜ^{k}}ₖ₌₁^{K}. In at least some embodiments, the server adheres to synchronous FL, in which the server waits for all computational devices to complete training. Therefore, Tₜ is defined as follows:

Tₜ=max{Tₜ^{k}}ₖ₌₁^{K} EQ. 2,

In at least some embodiments, one of the objectives is to reduce the training time for all devices in a round, which is different from minimizing Tₜ in EQ. 2. Tₜ is bound by the maximum training time among all participating computational devices. However, reducing the training time on individual computational devices brings the advantage of reducing the amount of computation carried out on the devices in at least some embodiments. Therefore, in at least some embodiments, an objective to reduce the training time for all devices within one round is defined as follows:

$${min}_{{μ}_{t}^{k}} \frac{1}{K} {\sum }_{k = 1}^{K} {T}_{t}^{k} subject to {T}_{t}^{k} = f ( {W}^{k} , {C}_{t}^{s} , {C}_{t}^{k} , {Net}_{t}^{k} , {μ}_{t}^{k} ) , \qquad EQ . 3$$

In at least some embodiments, the objective of reducing the total training time over all FL training rounds is achieved by lowering the average training time of all rounds for which μₜ is optimized for each round based on variable operational conditions Cₜ^{s}, Cₜ^{k}, and Netₜ^{k}.

$${min}_{{μ}_{t}} \frac{1}{R} {\sum }_{t = 1}^{R} {T}_{t} \\ subject to {T}_{t} = max {\{ {T}_{t}^{k} \}}_{k = 1}^{K} \\ {T}_{t}^{k} = f ( {W}^{k} , {C}_{t}^{s} , {C}_{t}^{k} , {Net}_{t}^{k} , {μ}_{t}^{k} ) \\ {μ}_{t} = {\{ {μ}_{t}^{k} \}}_{k = 1}^{K} , \qquad EQ . 4$$

In at least some embodiments, the partitioning section generates an offloading decision for each computational device. In at least some embodiments, the partitioning section generates an offloading decision for each group of computational devices. In at least some embodiments, as the number of computational devices increases, the partitioning section performs better according to the objective of reducing the total training time over all FL training rounds by generating offloading decisions for groups of computational devices rather than individual computational devices.

In at least some embodiments, the partitioning section performs clustering during the partitioning before each FL round. In at least some embodiments of the clustering process, the partitioning section clusters homogeneous computational devices according to the training time per iteration, such as one iteration of the operations S332 to S335 in FIG. 3, and network bandwidth between the device and server into G groups. In at least some embodiments, the number of groups are determined by one or more hyperparameters. In at least some embodiments, G groups are used instead of K computational devices for input attributes and observations and output offloading decisions. In at least some embodiments, the objectives formulated in EQ. 5 and EQ. 6 are considered instead of EQ. 3 and EQ. 4, respectively.

$${min}_{{μ}_{t}^{g}} \frac{1}{G} {\sum }_{g = 1}^{G} {T}_{t}^{g} \\ subject to {T}_{t}^{g} = f ( {W}^{g} , {C}_{t}^{s} , {C}_{t}^{g} , {Net}_{t}^{g} , {μ}_{t}^{g} ) , \qquad EQ . 5$$

$${min}_{{μ}_{t}} \frac{1}{R} {\sum }_{t = 1}^{R} {T}_{t} \\ subject to {T}_{t} = max {\{ {T}_{t}^{g} \}}_{g = 1}^{G} {T}_{t}^{k} = f ( {W}^{g} , {C}_{t}^{s} , {C}_{t}^{g} , {Net}_{t}^{g} , {μ}_{t}^{g} ) \\ {μ}_{t} = {\{ {μ}_{t}^{g} \}}_{g = 1}^{G} , \qquad EQ . 6$$

where g is a representative computational device in the group that has the most training time among all groups. Therefore, W^{k}, Cₜ^{g}, Netₜ^{g}, μₜ^{g}, and Tₜ^{g} are bounded by the representative computational device in each group.

In at least some embodiments, the partitioning section is configured to adapt the offloading strategy in response to changes in the network bandwidth between the computational device and the server. In at least some embodiments, the partitioning algorithm is configured for network bandwidth input. In at least some embodiments, computational devices with limited network bandwidth are considered within an additional heterogeneous group, and computational devices are added to and removed from this group each round. At the beginning of each FL round in at least some embodiments, the network bandwidth of all computational devices are observed. In at least some embodiments, computational devices in which the network bandwidth drops below a threshold value are assigned to the additional group. In at least some embodiments where the partitioning algorithm is an RL Agent, the training of the RL Agent is carried out in a controlled environment such that the network bandwidth between the computational device and the server is limited to represent the group.

At S426, the partitioning section or a sub-section thereof partitions each instance of the neural network model corresponding to the computational devices of the group according to the offloading decision obtained at S450. In at least some embodiments, the partitioning section partitions, for each of a plurality of computational devices, a plurality of layers of a neural network model into a device partition and a server partition based on a computational capability attribute of the computational device and a network bandwidth attribute of the computational device.

At S428, the partitioning section or a sub-section thereof determines whether all of the groups of computational devices have been processed. If the partitioning section determines that there are remaining unprocessed groups, then the operational flow proceeds to S429 to select the next group before returning to partitioning algorithm application at S423. If the partitioning section determines that all groups have been processed, then the operational flow ends.

In at least some embodiments, the partitioning section uses a Reinforcement Learning-based (RL) partitioning model to address the challenge of computational heterogeneity of devices that leads to stragglers in FL. In at least some embodiments, this automated approach enables the partitioning section to identify the OP for each individual computational device before a round of FL, so that an executed offloading strategy is optimal for each device participating in an FL training round. In at least some embodiments, to reduce the challenge in scaling training for a large number of devices and in determining an offloading strategy that is optimal for all devices, a clustering-based approach is further employed to group devices that have similar computational performance. In at least some embodiments, once the offloading decision for each group of devices is determined by a trained RL partitioning model, the partitioning section will map the offloading decision on to each device to execute the offloading strategy to perform FL training.

In at least some embodiments, the partitioning section optimizes the RL partitioning model so that operational conditions, namely network bandwidth between the computational devices and the server, can be accounted for in generating optimal offloading strategies.

In at least some embodiments, the training process of the Reinforcement Learning (RL) agent is combined with a clustering technique. In order to train the RL Agent in at least some embodiments, the input state, output action and the reward function are defined. In at least some embodiments, the unsupervised learning that the RL Agent provides for generating offloading strategies for the participating computational devices does not require explicit profiling of the hardware on the computational device, which is not always possible in real applications. In at least some embodiments, the trained RL agent can be reused for similar FL tasks.

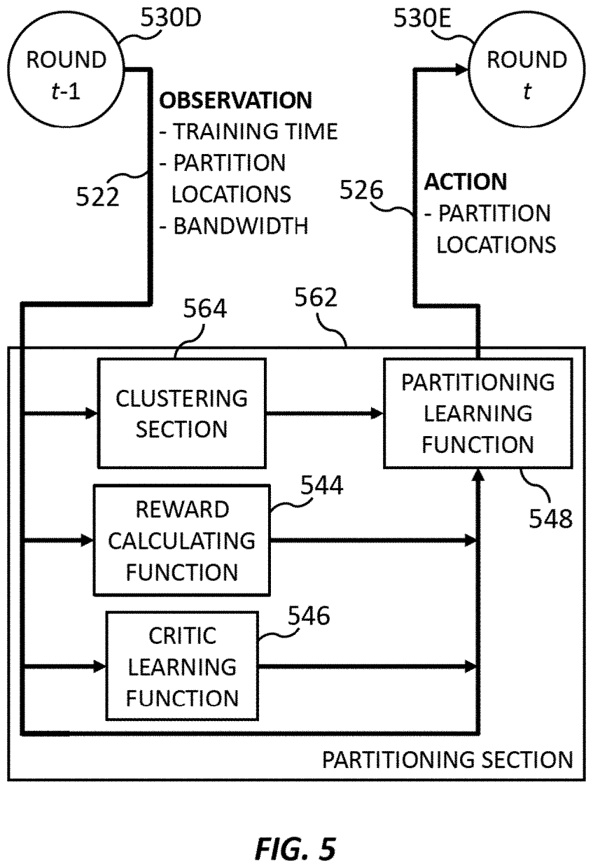

FIG. 5 is a schematic diagram of data flow for neural network model partitioning, according to at least one embodiment of the present invention. The diagram shows a data flow through a partitioning section 562, which includes a clustering section 564, a reward calculating section 544, a critic learning function 546, and a partitioning learning function 548, between Round t−1 (530D) and Round t (530E), where t ∈ [1, R].

After FL Round t−1 is complete, partitioning section 562 receives observations 522 including, for each computational device during Round t−1, the training time, the partition locations or offloading decision, and the network bandwidth between the corresponding computational device and the server. In at least some embodiments, partition section 562 distributes observations 522 to each of clustering section 564, reward calculating section 544, critic learning function 546, and partitioning learning function 548.

Although in at least some embodiments, the partitioning section is configured to generate an offloading action for each computational device, the number of participating computational devices would need to be fixed during FL training when using partitioning learning function 548 to generate offloading actions due to the fixed input and output dimensions of the neural network used by partitioning learning function 548. In at least some embodiments, as the number of computational devices K increases, the action space that will need to be explored to train partitioning learning function 548 increases. The action space grows exponentially with the increase in the number of computational devices. For example, for K computational devices and a DNN model with L layers, the size of the action space is L^{K}.

Clustering section 564 is configured to cluster the computational devices into groups. In at least some embodiments, clustering section 564 is configured to cluster the computational devices into groups based on the information in observation 522 and information of the server, such as server training time. Clustering section 564 is configured to transmit group information to partitioning learning function 548. In at least some embodiments, clustering section 564 is configured to determine representative information for each group of computational devices, and transmit the representative information to partitioning learning function 548.

In at least some embodiments, partitioning learning function 548 is trained to generate a different output action in response to changes in the network bandwidth. In at least some embodiments in which partitioning learning function 548 is trained for different network bandwidths, the rewards that are dominated by states in which the network bandwidth is not limited. To circumvent this, in at least some embodiments, computational devices with network bandwidth below a threshold are clustered into an additional heterogeneous group.

Reward calculating function 544 is configured to calculate a reward value based on the information in observation 522. In at least some embodiments, reward calculating function 544 compares the training time in observation 522 with the training time from Round 0, during which the server did not participate in the training process. Reward calculating function 544 is configured to transmit the reward value to partitioning learning function 548. In at least some embodiments, reward calculating function 544 is further configured to transmit the reward value to critic learning function 546.

Critic learning function 546 is a machine learning model trained to output an overall reward upon application to a state in the form of the information in observation 522, in view of prior states and actions in the form of offloading decisions, and possible future states and actions. In at least some embodiments, critic learning function 546 is configured to assist in the training of partitioning learning function 548 through the weight updating process. In at least some embodiments, critic learning function 546 is not further used once partitioning learning function 548 has completed training.

Partitioning learning function 548 is a machine learning model trained to output action 526 in the form of partition locations or an offloading decision upon application of a state in the form of the information in observation 522. In at least some embodiments, partitioning learning function 548 is configured to output an offloading decision for a group of computational devices based on the representative information received from clustering section 564.

In at least some embodiments, an episode of training a reinforcement learning function for neural network model partitioning is defined as an entire FL training task which includes R rounds, and a step is defined as one round of FL training. In at least some embodiments, the state is obtained from a clustering section, such as clustering section 564 in FIG. 5, and comprises normalized values. In at least some embodiments, the reinforcement learning function employs a neural network with three layers that obtains the current input state (Sₜ) as input, produces the offloading action Aₜ, which is a value between 0 and 1 for a computational device group to be mapped on to an OP for each computational device in the corresponding group. In at least some embodiments, a trained reinforcement learning function is obtained at the end of five episodes of FL rounds that maximizes the accumulated rewards over each step in line with EQ. 3 and EQ. 4. In at least some embodiments, the training process begins during Round 0, in which no computations are offloaded to the server, to generate the initial state S₀.

In at least some embodiments, only the largest training time among the computational devices in each group is included in an input state to the reinforcement learning function. In at least some embodiments, the reinforcement learning function in each training round will produce the OP for each group. In at least some embodiments, the partitioning section then maps the OP of a group to the DNNs of all devices in the group, which is μₜ^{g}. For instance, a VGG5 model with 3 convolutional layers and two fully connected layers will have 5 offloading actions. To allow the reinforcement learning function to adapt to DNN models with different number of layers, the output action for each group is designed to be a real value (μₜ^{g}) ranging from zero to one in at least some embodiments. In at least some embodiments, the output action ranging from zero to one is mapped to the percentage of the total computational workload of the DNN that is placed on the computational device. After obtaining μₜ^{g} in at least some embodiments, the Floating Point Operations (FLOPs) is calculated and set as the target workload on computational devices. In at least some embodiments, the partitioning section chooses the OP closest to the target workload. Equation 7 shows input state and output action at round t in at least some embodiments.

Sₜ={Tₜ^{g}, μₜ₋₁^{g}}_{g=1}^{G}

Aₜ={μₜ^{t}}_{g=1}^{G}

subject to μₜ^{g} ∈ [0, 1] EQ. 7,

In at least some embodiments, the reward function guides the training process of the reinforcement learning function. The reward obtained at the end of each FL training round is denoted as Rₜ. To achieve the objective of EQ. 3, at least some embodiments set the reward as the average training time. In at least some embodiments, a normalization function, such as fnorm, is used to calculate the reward in order to reduce the impact of devices with large training times on the reward.

In at least some embodiments, the training time for each computational device when there is no DNN model offloading to a server is referred to as a baseline, denoted as B^{k}. In at least some embodiments, the training time of computational device k(Tₜ^{k}) is normalized with B^{k} using EQ. 8 to reduce the variance of the rewards, thereby speeding up the training of the reinforcement learning function.

$${R}_{t} = {\sum }_{k = 1}^{K} {f}_{n o r m} ( {T}_{t}^{k} , {B}^{k} ) \\ {f}_{n o r m} = \{ \begin{matrix}1 - \frac{{T}_{t}^{k}}{{B}^{k}} {T}_{t}^{k} \leq {B}^{k} \\ 1 - \frac{{B}^{k}}{{T}_{t}^{k}} {T}_{t}^{k} > {B}^{k}\end{matrix} , \qquad EQ . 8$$

A variety of algorithms are available to train the reinforcement learning function for achieving the objectives presented herein, such as REINFORCE, Proximal Policy Optimization (PPO), etc. Compared to on-policy algorithms, such as REINFORCE, PPO is an off-policy RL algorithm, which repeatedly uses trajectory data from previous explorations (interactions between the agent and the environment). In at least some embodiments, PPO improves the training efficiency given that exploration is time consuming over REINFORCE as the training algorithm of the reinforcement learning function.

In at least some embodiments, the reinforcement learning function comprises two fully connected networks, namely the actor and critic networks, which have the same architecture comprising three layers. In at least some embodiments, the critic network is adopted for assisting the training of the actor network to output the offloading action. After completing training in at least some embodiments, only the actor network will be used to provide the offloading action. In at least some embodiments, the reinforcement learning function is trained online during an FL task, such that the learning time is the time for all rounds in FL training. To accelerate the training of the reinforcement learning function, so that the reinforcement learning function does not need to wait until the completion of each round to obtain the training time required for calculating the reward, the number of iterations required for each round of FL training is reduced. In at least some embodiments, the input state and output action are calculated using the training time per iteration, such as operations S332 to S335 in FIG. 3, for each computational device instead of the training time of one round, such as operation S230 in FIG. 2, for each computational device. Since the reduced iterations in each FL round would affect the accuracy of the neural network model being trained, the neural network model is trained with rounds of full iterations after the trained reinforcement learning function is obtained in at least some embodiments.

In at least some embodiments, the reinforcement learning function is first trained for 50 rounds, and then deployed as a trained agent to the FL task for generating offloading strategies during each round. During training of the reinforcement learning function in at least some embodiments, the number of iterations in one round of FL is reduced from 100 to 5 iterations. In at least some embodiments, the reinforcement learning function has an actor network and a critic network having the same architecture of fully connected layers with two hidden layers (64 and 32 neurons, receptively). In at least some embodiments, the actor network is used to generate the offloading actions whereas the critic network evaluates the value of a given state. During training in at least some embodiments, a discount factor γ=0.9 is set for the reinforcement learning function to determine the importance of using reward from future states, and the learning rates for the actor and critic networks are configured to be 1e-4. In at least some embodiments, the weights of the actor and critic networks are updated every 10 rounds, and during each update the data collected in the previous 10 rounds are used 50 times. In at least some embodiments, the standard deviation of the actor network is set as 0.5 at the beginning of the training of the reinforcement learning function, and exponentially decayed (decay rate 0.9) after 200 rounds of training to increase freedom to explore the action space in the first 200 rounds, and improve the ability to produce actions that can generate offloading strategies that will reduce the training time after the first 200 rounds.

In at least some embodiments, to accommodate large numbers of computational devices, distributed reinforcement learning functions are used with hierarchical clustering of devices. In at least some embodiments, techniques such as quantization may reduce the communication cost.

FIG. 6 is a block diagram of an exemplary hardware configuration for adaptive offloading of federated learning, according to at least one embodiment of the present invention.

The exemplary hardware configuration includes server 600, which communicates with a plurality of computational devices 610A, 610B, and 610C through network 609, and interacts with input device 607. Server 600 may be a computer or other computing device that receives input or commands from input device 607. Server 600 may be a host server that connects directly to input device 607, or indirectly through network 609. In some embodiments, server 600 is a computer system that includes two or more computers. In some embodiments, server 600 is a personal computer that executes an application for a user of server 600.

Server 600 includes a controller 602, a storage unit 604, a communication interface 608, and an input/output interface 606. In some embodiments, controller 602 includes a processor or programmable circuitry executing instructions to cause the processor or programmable circuitry to perform operations according to the instructions. In some embodiments, controller 602 includes analog or digital programmable circuitry, or any combination thereof. In some embodiments, controller 602 includes physically separated storage or circuitry that interacts through communication. In some embodiments, storage unit 604 includes a non-volatile computer-readable medium capable of storing executable and non-executable data for access by controller 602 during execution of the instructions. Communication interface 608 transmits and receives data from network 609. Input/output interface 606 connects to various input and output units via a parallel port, a serial port, a keyboard port, a mouse port, a monitor port, and the like to accept commands and present information.

Controller 602 includes partitioning section 662, clustering section 664, training section 666, and aggregating section 668. Storage unit 604 includes neural networks 671, partitions 672, training parameters 674, aggregating parameters 676, and partitioning parameters 678.

Partitioning section 662 is the circuitry or instructions of controller 602 configured to partition neural network models. In at least some embodiments, partitioning section 662 is configured to partition neural network models into device partitions and server partitions. In at least some embodiments, partitioning section 662 reads neural networks 671 from storage unit 604, and stores partitions 672 in storage unit 604, according to partitioning parameters 678 in storage unit 604. In at least some embodiments, partitioning section 662 includes sub-sections for performing additional functions, as described in the foregoing flow charts. In at least some embodiments, such sub-sections may be referred to by a name associated with their function.

Clustering section 664 is the circuitry or instructions of controller 602 configured to cluster computational devices into groups. In at least some embodiments, clustering section 664 is configured to cluster computational devices into groups based on their computational capability attributes and network bandwidth attribute. In at least some embodiments, clustering section 664 utilizes information in storage unit 604, such as partitioning parameters 678. In at least some embodiments, clustering section 664 includes sub-sections for performing additional functions, as described in the foregoing flow charts. In at least some embodiments, such sub-sections may be referred to by a name associated with their function.

Training section 666 is the circuitry or instructions of controller 602 configured to perform operations to train neural network models. In at least some embodiments, training section 666 is configured to perform coordinated training with a plurality of computational devices. In at least some embodiments, training section 666 utilizes information in storage unit 604, such as partitions 672 and training parameters 674. In at least some embodiments, training section 666 includes sub-sections for performing additional functions, as described in the foregoing flow charts. In at least some embodiments, such sub-sections may be referred to by a name associated with their function.

Aggregating section 668 is the circuitry or instructions of controller 602 configured to aggregate neural network models to product a global neural network model. In at least some embodiments, aggregating section 668 is configured to average weights of neural networks of each of a plurality of computational devices. In at least some embodiments, aggregating section 668 utilizes information in storage unit 604, such as neural networks 671 and aggregating parameters 676. In at least some embodiments, aggregating section 668 includes sub-sections for performing additional functions, as described in the foregoing flow charts. In at least some embodiments, such sub-sections are referred to by a name associated with the corresponding function.

In at least some embodiments, the server is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the server is a computer, a program that is installed in the computer is capable of causing the computer to function as or perform operations associated with servers of the embodiments described herein. In at least some embodiments, such a program is executable by a processor to cause the computer to perform certain operations associated with some or all of the blocks of flowcharts and block diagrams described herein.

Various embodiments of the present invention are described with reference to flowcharts and block diagrams whose blocks may represent (1) steps of processes in which operations are performed or (2) sections of a controller responsible for performing operations. Certain steps and sections are implemented by dedicated circuitry, programmable circuitry supplied with computer-readable instructions stored on computer-readable media, and/or processors supplied with computer-readable instructions stored on computer-readable media. In some embodiments, dedicated circuitry includes digital and/or analog hardware circuits and may include integrated circuits (IC) and/or discrete circuits. In some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Various embodiments of the present invention include a system, a method, and/or a computer program product. In some embodiments, the computer program product includes a computer readable storage medium (or media) having computer readable program instructions thereon for causing a processor to carry out aspects of the present invention.

In some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein are downloadable to respective computing/processing devices from a computer readable storage medium or to an external computer or external storage device via a network, for example, the Internet, a local area network, a wide area network and/or a wireless network. In some embodiments, the network may includes copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, the computer readable program instructions are executed entirely on the user's computer, partly on the user's computer, as a stand-alone software package, partly on the user's computer and partly on a remote computer or entirely on the remote computer or server. In some embodiments, in the latter scenario, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. It will be apparent to persons skilled in the art that various alterations and improvements can be added to the above-described embodiments. It will also be apparent from the scope of the claims that the embodiments added with such alterations or improvements are included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

According to at least one embodiment of the present invention, adaptive offloading of federated learning is performed by partitioning, for each of a plurality of computational devices, a plurality of layers of a neural network model into a device partition and a server partition based on a computational capability attribute of the computational device and a network bandwidth attribute of the computational device, training, cooperatively with respect to each computational device through the network, the neural network model, and aggregating the updated weight values of neural network model instances received from the plurality of computational devices to generate an updated neural network model.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a server to cause the server to perform operations comprising:
partitioning, for each of a plurality of computational devices, a plurality of layers of a neural network model into a device partition and a server partition based on a computational capability attribute of the computational device and a network bandwidth attribute of the computational device;
training, cooperatively with respect to each computational device through the network, the neural network model by
transmitting, to the computational device, the corresponding device partition,
receiving, from the computational device, feature maps output from the corresponding device partition,
applying the corresponding server partition to the feature maps,
updating gradient values and weight values of the layers of the corresponding server partition based on a loss function relating feature maps to output of the corresponding server partition, and
transmitting, to the computational device, gradient values of a layer bordering the corresponding device partition,
receiving, from the computational device, the corresponding device partition having updated weight values, and
combining the corresponding server partition having updated weight values with the corresponding device partition having updated weight values to form a corresponding neural network model instance having updated weight values;
aggregating the updated weight values of neural network model instances received from the plurality of computational devices to generate an updated neural network model.

2. The computer-readable medium of claim 1, further comprising:
initializing the neural network model with random weight values;
transmitting, to each of the plurality of computational devices through the network, a corresponding instance of the initialized neural network model;
receiving, from each of the plurality of computational devices through the network, a corresponding instance of the neural network model having updated weight values;
aggregating the updated weight values of the instances of the neural network model received from the plurality of computational devices to generate an updated neural network model;
wherein the updated neural network model is used as the neural network model in the partitioning.

3. The computer-readable medium of claim 1, wherein
the partitioning includes clustering, into a group among a plurality of groups, one or more computational devices among the plurality of computational devices based on a similarity of the computational capability attribute of each computational device and further based on a similarity of the network bandwidth attribute of each computational device, and
the partitioning is based on the group of each computational device.

4. The computer-readable medium of claim 3, wherein the partitioning further includes obtaining the computational capability attribute and the network bandwidth attribute for each of the plurality of computational devices.

5. The computer-readable medium of claim 4, further comprising
performing a plurality of rounds, each round including the partitioning, the training, and the aggregating,
wherein, for each round, the neural network model subjected to the partitioning and the training is the updated neural network model resulting from the aggregating of a preceding round.

6. The computer-readable medium of claim 5, wherein
the partitioning is based on a partitioning algorithm that relates a training time of each group to the computational capability attributes of the corresponding group among the plurality of groups obtained during the preceding round, the network bandwidth attributes of the corresponding group among the plurality of groups obtained during the preceding round, a computational capabilities attribute of the server, a number of computations performed by the corresponding device during the training, and a partition location within the neural network model, the training time of each group being a representative amount of time used during the training.

7. The computer-readable medium of claim 6, wherein the partitioning includes determining, according to the partitioning algorithm for each group, a partition location that reduces the corresponding training time.

8. The computer-readable medium of claim 6, wherein the partitioning algorithm is a partitioning model trained to output the partition location using a loss function based on the training time.

9. The computer-readable medium of claim 8, further comprising
training a reinforcement learning function to produce the partitioning model;
wherein the training of the reinforcement learning function includes, for each round, calculating a reward based on amounts of time used by the plurality of groups to train the neural network model without partitioning.

10. The computer-readable medium of claim 9, wherein the training of the reinforcement learning function includes training a critic learning function having equivalent architecture to the reinforcement learning function.

11. The computer-readable medium of claim 9, wherein the training of the reinforcement learning function includes
limiting iterations of the training of the neural network model, and
substituting the training time with a representative amount of time between receiving feature maps during the training of the neural network model by the corresponding group.

12. A method comprising:
partitioning, for each of a plurality of computational devices, a plurality of layers of a neural network model into a device partition and a server partition based on a computational capability attribute of the computational device and a network bandwidth attribute of the computational device;
training, cooperatively with respect to each computational device through the network, the neural network model by
transmitting, to the computational device, the corresponding device partition,
receiving, from the computational device, feature maps output from the corresponding device partition,
applying the corresponding server partition to the feature maps,
updating gradient values and weight values of the layers of the corresponding server partition based on a loss function relating feature maps to output of the corresponding server partition, and
transmitting, to the computational device, gradient values of a layer bordering the corresponding device partition,
receiving, from the computational device, the corresponding device partition having updated weight values, and
combining the corresponding server partition having updated weight values with the corresponding device partition having updated weight values to form a corresponding neural network model instance having updated weight values;
aggregating the updated weight values of neural network model instances received from the plurality of computational devices to generate an updated neural network model.

13. The method of claim 12, further comprising:
initializing the neural network model with random weight values;
transmitting, to each of the plurality of computational devices through the network, a corresponding instance of the initialized neural network model;
receiving, from each of the plurality of computational devices through the network, a corresponding instance of the neural network model having updated weight values;
aggregating the updated weight values of the instances of the neural network model received from the plurality of computational devices to generate an updated neural network model;
wherein the updated neural network model is used as the neural network model in the partitioning.

14. The method of claim 13, wherein
the partitioning includes clustering, into a group among a plurality of groups, one or more computational devices among the plurality of computational devices based on a similarity of the computational capability attribute of each computational device and further based on a similarity of the network bandwidth attribute of each computational device, and
the partitioning is based on the group of each computational device.

15. The computer-readable medium of claim 14, wherein the partitioning further includes obtaining the computational capability attribute and the network bandwidth attribute for each of the plurality of computational devices.

16. The method of claim 15, further comprising
performing a plurality of rounds, each round including the partitioning, the training, and the aggregating,
wherein, for each round, the neural network model subjected to the partitioning and the training is the updated neural network model resulting from the aggregating of a preceding round.

17. The method of claim 16, wherein
the partitioning is based on a partitioning algorithm that relates a training time of each group to the computational capability attributes of the corresponding group among the plurality of groups obtained during the preceding round, the network bandwidth attributes of the corresponding group among the plurality of groups obtained during the preceding round, a computational capabilities attribute of the server, a number of computations performed by the corresponding device during the training, and a partition location within the neural network model, the training time of each group being a representative amount of time used during the training.

18. The method of claim 17, wherein the partitioning includes determining, according to the partitioning algorithm for each group, a partition location that reduces the corresponding training time.

19. The computer-readable medium of claim 17, wherein the partitioning algorithm is a partitioning model trained to output the partition location using a loss function based on the training time.

20. An apparatus comprising:
a controller including circuitry configured to
partition, for each of a plurality of computational devices, a plurality of layers of a neural network model into a device partition and a server partition based on a computational capability attribute of the computational device and a network bandwidth attribute of the computational device;
train, cooperatively with respect to each computational device through the network, the neural network model by
transmitting, to the computational device, the corresponding device partition,
receiving, from the computational device, feature maps output from the corresponding device partition,
applying the corresponding server partition to the feature maps,
updating gradient values and weight values of the layers of the corresponding server partition based on a loss function relating feature maps to output of the corresponding server partition, and
transmitting, to the computational device, gradient values of a layer bordering the corresponding device partition,
receiving, from the computational device, the corresponding device partition having updated weight values, and
combining the corresponding server partition having updated weight values with the corresponding device partition having updated weight values to form a corresponding neural network model instance having updated weight values;
aggregate the updated weight values of neural network model instances received from the plurality of computational devices to generate an updated neural network model.
